(19) United States
(12) Patent Application Publication
(10) Pub. No.: US 2010/0233076 A1
(43) Pub. Date: Sep. 16, 2010

(54) Hydrogen Storage Materials

(75) Inventors: Donald J. Siegel, Ann Arbor, MI (US); Christopher Mark Wolverton, Evaston, IL (US); Vidvuds Ozolins, Santa Monica, CA (US); Andrea Sudik, Canton, MI (US); Jun Yang, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignees: FORD GLOBAL TECHNOLOGIES, LLC, Dearborn, MI (US); THE REGENTS OF THE UNIVERSITY OF CALIFORNIA, Oakland, CA (US)

(21) Appl. No.: 12/561,336

(22) Filed: Sep. 17, 2009

Related U.S. Application Data
(60) Provisional application No. 61/097,999, filed on Sep. 18, 2008.

(51) Int. Cl. C01B 3/04; C09K 3/00

(52) U.S. Cl. 423/648.1; 252/183.14

(57) ABSTRACT

According to at least one aspect of the present invention, a hydrogen storage material is provided. In at least one embodiment, the material comprises a borohydride compound of the formula M(BH₄)ₙ, wherein M includes Ca and n is an integer of 2 to 6; and a destabilizing agent selected from the group consisting of Cr, ScH₂, and combinations thereof. In at least another embodiment, the material comprises a metal borohydride M(BH₄)ₙ, wherein M includes Li and n is an integer of 1 to 5, and a destabilizing agent of Cr.

### CROSS-REFERENCE TO RELATED APPLICATIONS

This application claims the benefit of U.S. provisional application Ser. No. 61/097,999 filed Sep. 18, 2008.

### BACKGROUND

1. Technical Field

One or more embodiments of the present invention relate to hydrogen storage materials and methods for supplying hydrogen.

2. Background Art

Hydrogen is desirable as a source of energy for many applications because its reaction with air produces a clean by-product of water. Hydrogen has increasingly been considered an environmentally benign energy carrier in the field of mobile or stationary applications.

However, use of hydrogen as an energy carrier has been met with many implementation challenges. For example, efficient storage and release of hydrogen is identified as one of the key practical obstacles to realizing a transition to hydrogen-powered vehicles.

### SUMMARY OF THE INVENTION

According to at least one aspect of the present invention, a hydrogen storage material is provided. In at least one embodiment, the material comprises a borohydride compound of the formula M(BH₄)ₙ, wherein M includes Ca and n is an integer of 2 to 6, and a destabilizing agent selected from the group consisting of Cr, ScH₂, or combinations thereof.

In at least one particular embodiment, the borohydride compound is Ca(BH₄)₂ and the destabilizing agent is ScH₂. In certain particular instances, Ca(BH₄)₂ and ScH₂ are present in a molar ratio of 1:1.

In at least yet another particular embodiment, the borohydride compound is Ca(BH₄)₂ and the destabilizing agent is Cr. In certain instances, Ca(BH₄)₂ and Cr are present in a molar ratio of from 0.8:1.0 to 1.2:1.0.

In at least another embodiment, the material comprises a borohydride compound of the formula M(BH₄)ₙ, wherein M includes Li and n is an integer of 1 to 5, and a destabilizing agent of Cr. In at least one particular embodiment, the borohydride compound is LiBH₄. In certain instances, LiBH₄ and Cr are present in a molar ratio of from 1.8:1.0 to 2.2:1.0.

In at least another embodiment, the borohydride compound further includes a secondary element selected from the group consisting of Na, K, Mg, Sr, Mn, Ti, Al, Zr, Zn, and combinations thereof.

In at least yet another embodiment, the borohydride compound is configured as a number of particles.

In at least yet another embodiment, the borohydride compound and the destabilizing agent collectively release hydrogen with a reactive enthalpy in the range of 20 to 50×10³ Joule per mole (hereinafter kJ/mol) hydrogen.

In at least yet another embodiment, the borohydride and the destabilizing agent collectively release hydrogen at a temperature between −40 to 80 degrees Celsius.

In at least yet another embodiment, the metal borohydride compound has a single-crystal volumetric hydrogen density about 50 percent higher than liquid hydrogen.

According to at least another aspect of the present invention, a method is provided for storing and releasing hydrogen. In at least one embodiment, the method comprises providing a hydrogen storage material comprising: a borohydride compound of the formula M(BH₄)ₙ, wherein M includes Ca and n is an integer of 2 to 6; and a destabilizing agent selected from the group consisting of Cr, ScH₂, and combinations thereof; and inducing the hydrogen storage material to release hydrogen stored within the borohydride compound.

In at least another embodiment, the step of inducing is conducted at a temperature of between −40 and 80 degrees Celsius.

In at least yet another embodiment, the step of inducing is conducted at a pressure of between 1 to 700 bar.

In at least yet another embodiment, the step of inducing is conducted with a reactive enthalpy of between 20 to 50 kJ/mol hydrogen.

### BRIEF DESCRIPTION OF THE DRAWINGS

FIG. 1 depicts calculated van't Hoff plot for reactions listed in Table 1.

### DETAILED DESCRIPTION OF EMBODIMENTS OF THE INVENTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Practice within the numerical limits stated is generally preferred. Also, unless expressly stated to the contrary, the description of a group or class of material as suitable or preferred for a given purpose in connection with the invention implies that mixtures of any two or more members of the group or class may be equally suitable or preferred.

Metal hydrides such as LaNi₅H₆ have long been known to reversibly store hydrogen at volumetric densities surpassing that of liquid hydrogen, but their materials density often results in gravimetric densities that are too low for lightweight applications.

Other efforts have been focused on the use of metal borohydrides as potential hydrogen storage materials since borohydrides such as LiBH_{d} have a relatively high potential to store a large quantity of hydrogen, e.g., up to 18.5 weight percent of hydrogen. Nevertheless, the thermodynamics of hydrogen desorption from known borohydrides alone are generally incompatible with the temperature-pressure conditions of fuel cell operation. In the case of LiBH_{d} when used alone, a hydrogen-desorption temperature in excess of 300 degrees Celsius is often needed to directly release hydrogen from LiBH₄. Therefore, these existing hydrogen storage materials are met with limited use.

Further efforts have been made to discover hydrogen storage materials that are thermodynamically practical. For example, MgH₂ has been used as a destabilizer to facilitate hydrogen desorption from LiBH₄, yet only to a limited extent. The destabilizing effect of MgH₂ results in somewhat decreased hydrogen-desorption temperature of about 225 degrees Celsius compared to 300 degrees Celsius when LiBH₄ is used alone. However, the temperature of 225 degrees Celsius is still too high and hence impractical for mobile applications.

The temperature for hydrogen desorption from a solid state storage material at certain fixed pressure is largely determined by the enthalpy of hydrogen release reactions. To release hydrogen at about 1-700 bar between 0 to 85 degrees Celsius, the hydrogen storage material ideally should have an enthalpy of desorption reaction in the range of about 20 to 50 kJ/mol hydrogen. Known materials that release hydrogen below 85 degrees Celsius typically reversibly store only about 1-3 weight percent of hydrogen. Examples of these prior art hydrogen storage materials include LaNi₅, TiFe, and NaAlH₄. Other prior art hydrogen storage materials having acceptable hydrogen density yet have enthalpies for releasing hydrogen well outside the acceptable range of 20 to 50 kJ/mol hydrogen. Enthalpies higher than 50 kJ/mol hydrogen indicate that hydrogen is bound too strongly to a hydrogen storage material and hence the hydrogen release on board of a motor vehicle may be largely impractical. Enthalpies lower than 20 kJ/mol hydrogen indicate hydrogen is bound too loosely to a hydrogen storage material and hence the release thereof may be often premature, and recharging and/or rehydriding can require use of impractically high pressures. Thus, a targeted enthalpy for releasing hydrogen from a hydrogen storage material is desirably in the range of about 20-50 kJ/mol hydrogen.

As used herein in one or more embodiments and unless otherwise noted, the term “release of hydrogen” or “desorption of hydrogen” refers to liberation of hydrogen from the hydrogen storage material. It is not intended to indicate that complete release has necessarily occurred, and contemplates both a complete release and a partial release resulting from liberation of at least part of the hydrogen content of the material.

It has been found, according to one or more embodiments of the present invention, that certain hydrogen storage materials through the application of thermodynamic destabilization are useful to generating hydrogen as a readily available energy source for mobile and stationary applications. The concept of thermodynamic destabilization appears to offer opportunities for assessing hydrogen density of hydrogen storage solids. However, the large number of hydrides and destabilizing agents renders experimentally testing of all the possible combinations of known hydrogen storage solids impractical.

According to at least one embodiment, a series of hydrogen storage materials are provided to be useful for generating hydrogen in mobile and stationary applications wherein reactions using these hydrogen storage materials are uncovered through first-principles thermodynamic calculations based on density functional theory. The mobile and stationary applications may include fuel cell vehicles, hydrogen ICE (Internal Combustion Engine) vehicles, energy storage for intermittent power generation. These reactions, as described in more detail below, are identified to have favorable Gibbs free energies of hydrogen release in conjunction with appreciable gravimetric density of the range of 5-9 weight percent (defined as 5-9 grams hydrogen per 100 grams of a respective borohydride compound) and volumetric density of 85-100 grams hydrogen per liter of a respective borohydride compound.

An advantage of the embodiments of the present invention is that certain hydrogen storage materials are based on established synthesis routes, e.g. materials based on reactions 11, 18 and 22 of the Table 1 described below, such that the utilization of these materials is afforded with immediate and appreciable economical advantages.

According to at least one aspect of the present invention, a hydrogen storage material is provided. In at least one embodiment, the hydrogen storage material comprises a borohydride compound of the formula M(BH₄)ₙ, wherein M includes Ca and n is an integer of 2 to 6; and a destabilizing agent selected from the group consisting of Cr, ScH₂, and combinations thereof.

In at least one particular embodiment, the borohydride compound is Ca(BH₄)₂ (calcium borohydride) and the destabilizing agent is ScH₂ (scandium hydride). In certain instances, Ca(BH₄)₂ and ScH₂ are present in a molar ratio of from 0.8:1.0 to 1.2:1.0, of from 0.85:1.0 to 1.15:1.0, of from 0.9:1.0 to 1.1:1.0, or of from 0.95:1.0 to 1.05:1.0. In certain particular instances, the molar ratio between Ca(BH₄)₂ and ScH₂ is about 1:1.

In at least yet another particular embodiment, the borohydride compound is Ca(BH₄)₂ and the destabilizing agent is Cr (chromium). In certain instance, Ca(BH₄)₂ and Cr are present in a molar ratio of from 0.8:1.0 to 1.2:1.0, of from 0.85:1.0 to 1.15:1.0, of from 0.9:1.0 to 1.1:1.0, or of from 0.95:1.0 to 1.05:1.0. In certain particular instances, the molar ratio between Ca(BH₄)₂ and Cr is about 1:1.

In at least another embodiment, the material comprises a borohydride compound of the formula M(BH₄)ₙ, wherein M includes Li and n is an integer of 1 to 5, and a destabilizing agent of Cr. In at least one particular embodiment, the borohydride compound is LiBH₄. In certain instances, LiBH₄ and Cr are present in a molar ratio of from 1.8:1.0 to 2.2:1.0, of from 1.85:1.0 to 2.15:1.0, of from 1.9:1.0 to 2.1:1.0, or of from 1.95:1.0 to 2.05:1.0. In certain particular instances, the molar ratio between Ca(BH₄)₂ and ScH₂ is about 2:1.

In at least yet another embodiment, M of the formula M(BH₄)ₙ further includes a secondary element Q. As such, the formula M(BH₄)ₙ may alternatively be presented as MQ(BH₄)ₙ, wherein M is either Ca, Li, or combinations thereof and Q is a nullity or selected from the group consisting of Na (sodium), K (potassium), Mg (magnesium), Sr (strontium), Mn (manganese), Ti(titanium), Al (aluminium), Zr (zirconium), Zn (zinc), and combinations thereof. Some suitable examples of such borohydride compound include LiNa(BH₄)₂, LiK(BH₄)₂, LiMg(BH₄)₃, LiSr(BH₄)₃, LiMn(BH₄)₃, LiZr(BH₄)₃, LiZn(BH₄)₂, Li₂Mg(BH₄)₄, LiAl(BH₄)₄, LiMg₂(BH₄)₅, LiTi(BH₄)₅, LiSr₂(BH₄)₅, NaCa(BH₄)₃, KCa(BH₄)₃, Mg₂Ca(BH₄)₄, Na₂Ca(BH₄)₄, K₂Ca(BH₄)₄, MgCa(BH₄)₄, SrCa(BH₄)₄, MnCa(BH₄)₄, ZrCa(BH₄)₄, ZnCa(BH₄)₄, NaCa₂(BH₄)₅, KCa₂(BH₄)₅, CaAl(BH₄)₅, Na₂K₂Ca(BH₄)₆, NaAlCa(BH₄)₆, KAlCa(BH₄).

In at least yet another embodiment, the hydrogen storage material further includes one or more dopants. Suitable dopants are compounds of the transition metals of groups three to five of the periodic table such as Y(yttrium), Ti (titanium), Zr (zirconium), Hf (hafnium), V (vanadium), Nb (niobium), Ta (tantalum)) as well as compounds of iron, nickel and the rare earth metals including La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetrium)). In certain instances, dopants are alcoholates, halides, hydrides and organometallic and intermetallic compounds of the mentioned metals. Combinations thereof may also be employed. For certain applications, the hydrogen storage material may include one or more dopants in an amount of no greater than 1% (percent), 2%, 5%, 10%, 20%, 30%, 40%, 50% or 60% by weight.

In at least yet another particular embodiment, the hydrogen storage material may be mechanically processed into a pre-activated form. For some applications, the mechanical process serves simply to agitate or stir the hydrogen storage material. In one particular embodiment, the mechanical process reduces the size of the particles in the hydrogen storage materials.

The mechanical processing methods illustratively include mixing, grinding, milling, or combinations thereof. In certain situations, the following mechanical processes are used: manual mixing, mechanically assisted mixing, ball milling, manual grinding, attritor milling, sand milling, horizontal milling, vertical milling, jet milling, jaw crusher milling, hammer milling, and high pressure dispersion milling.

The milling process can be any one or combination of milling processes known in the art. For example, the milling process can include media made of granular material (i.e., media milling). Some examples of suitable media milling processes include ball milling, attritor milling, sand milling, horizontal milling, and vertical milling.

In certain applications, hydrogen storage materials may be subjected to particle size reduction using an exemplary high energy planetary ball milling method. A stainless steel mill vial about the size of 250 cubic centimeters is equipped with a pressure transducer and thermometer, which allow instantaneous radio transmission of pressure and temperature data during milling. Milled materials may be evaluated by two means: 1) temperature programmed desorption (TPD), whereby the material being tested is heated at a constant rate such as 2 degrees Celsius per minute, and the released hydrogen and other gas signals are monitored; 2) the materials are decomposed at a fixed temperature and the evolved hydrogen is collected. Ball milled material particle sizes are roughly estimated from scanning electron microscope (SEM) examination. X-ray diffraction (XRD) studies are performed on as-ball-milled, partially desorbed and fully desorbed samples.

For certain applications, the borohydride compound may further contain a functional group illustratively including methyl, ethyl, dimethyl, diisobutyl, halogen, and combinations thereof, and/or a solvent molecule illustratively including ammonia, tetrahydrofuran (THF), and combinations thereof.

The hydrogen storage material can also be in any suitable physical form. For example, the hydrogen storage and desorption material can be in particulate form, e.g., powder, crystalline, polycrystalline, microcrystalline, pelletized, granular, and so on.

The size of the particles is not particularly critical to the operability of the present invention. For example, any one or more dimensions of the particles can be one centimeter or less, 50 millimeters or less, 40 millimeters or less, 30 millimeters or less, 20 millimeters or less, 10 millimeters or less, 1 millimeter or less, 500 micrometers or less, 250 micrometers or less, 100 micrometers or less, 50 micrometers or less, 20 micrometers or less, 10 micrometers or less, 1 micron or less, 500 nanometers or less, 250 nanometers or less, 100 nanometers or less, 50 nanometers or less, and so on.

The particles of hydrogen storage material can also have any of several morphologies. For example, the particles can be approximately spherical, oblong, rectangular, square planar, trigonal bipyramidal, cylindrical, octahedral, cubooctahedral, icosahedral, rhombohedral, rod-shaped, cuboidal, pyramidal, amorphous, and so on.

Alternatively, the hydrogen storage material can be in non-particulate form, e.g., in block form, in sheet form, as a coating, a film, an interconnected or interwoven network, or a combination thereof.

According to at least another aspect of the present invention, a method is provided for storing and releasing hydrogen. In at least one embodiment, the method comprises providing a hydrogen storage material comprising: a metal borohydride compound of the formula M(BH₄)ₙ, wherein M includes Ca and n is an integer of 2 to 6; and a destabilizing agent selected from the group consisting of Cr, ScH₂, and combinations thereof; and inducing the hydrogen storage material to release hydrogen stored within the metal borohydride compound.

In at least another embodiment, the method comprises providing a hydrogen storage material comprising: a metal borohydride compound of the formula M(BH₄)ₙ, wherein M includes Li and n is an integer of 1 to 5; and a destabilizing agent of Cr; and inducing the hydrogen storage material to release hydrogen stored within the metal borohydride compound.

In at least another embodiment, the step of inducing is conducted at a temperature in a range of no less than −80, −70, −60, or −50, to no greater than 100, 120, 140, 160 degrees Celsius. In certain particular instances, the step of inducing is conducted at a temperature of between −40 and 80 degrees Celsius.

In at least yet another embodiment, the step of inducing is conducted at a pressure of between 1 to 700 bar.

In at least yet another embodiment, the step of inducing is conducted with a reactive enthalpy of between 20 to 50 kJ/mol hydrogen.

### Example

### Methods

First-principles calculations are performed using a plane-wave-projector augmented wave method (VASP) based on the generalized gradient approximation to density functional theory wherein the energy of a collection of atoms, either in solid state or molecular form, is expressed in terms of the electron density. In the present example, density functional theory is used to calculate the Gibbs free energy change of various proposed hydrogen release reactions. All calculations employ a plane-wave cutoff energy of 400 eV, and k-point sampling is performed on a dense grid with an energy convergence of better than 1 meV per supercell. Internal atomic positions and external cell shape/volume are optimized to a tolerance of better than 0.01 eV/A. Thermodynamic functions are evaluated within the harmonic approximation, and normal-mode vibrational frequencies are evaluated using the so-called direct method on expanded supercells.

The search for high-density H₂-storage reactions is based on a series of candidate reactions that are analogous to equation (1)

$${yM ( {BH}_{4} )}_{n} + {AH}_{x} -> {yMH}_{n} + {AB}_{yn} + \frac{3 yn + x}{2} {H}_{2} , \qquad ( 1 )$$

where M=Li or Ca [n=1 (2) for Li (Ca)], A represents a metallic element, and coefficients x and y are selected based on the stoichiometries of known hydrides MHₓ and borides AB_{yn}. To maximize gravimetric density, A is one of the relatively lightweight elements near the top of the Periodic Table. In the case of M=Li, the enthalpy of the equation (1) per mol H₂ can be expressed as

$$Δ H = \frac{2}{3 y + x} [ \frac{3 y}{2} Δ {H}^{{LiBH}_{4}} + \frac{x}{2} Δ {H}^{{AH}_{x}} - Δ {H}^{{AB}_{y}} ] , \qquad ( 2 )$$

where ΔH corresponds to desorption (or formation) enthalpy of each of the respective hydrides (borides) per mol H₂ (or M). Thus, ΔH for the destabilized LiBH₄ reaction, shown as ΔH^{LiBH4}, is an average of the hydride desorption enthalpies, less the enthalpy of boride formation.

### Results

Table I lists theoretical hydrogen densities and calculated dehydrogenation enthalpies and entropies for several potential hydrogen-storage reactions. All reactants in each of the listed reactions have a known solid state crystal structure such that energy calculations may be carried out according to the methods section. Reactions 1-22 enumerate candidate reactions with reactions 23-27 being listed as internal controls. Accuracy of the instant methods is validated, at least partly, by comparing the calculated enthalpies of the internal controls to their counterpart experimentally measured enthalpies shown in parentheses.

Units are J/R mol H₂ for Δ_{svib} (vibrational entropy) and kJ/mol H₂ for ΔH; column 6 refers to the temperature at which P_{H}_{₂}=1 bar. Reactions denoted with a * will not proceed as written (see text). The enthalpies of reactions 24-27 have been measured in prior experiments and are included here (in parentheses) to validate the accuracy of our calculations. For comparison, optimal gravimetric density is in the range of 5-9 grams hydrogen per 100 grams of borohydride compound; and volumetric density is in the range of 45-81 grams hydrogen per liter of the borohydride compound.

TABLE 1
hydrogen densities and calculated thermodynamic quantities
for candidate hydrogen storage reactions

| | | grams | grams | | T, P = 1 | |
|---|---|---|---|---|---|---|
| Rxn. | | H₂ per | H₂ per | | bar | |
| No. | Reaction | 100 g | liter | ΔH^{T=300 K} | (° C.) | ΔS_{vib}^{T=300 K} |
| 1* | 4LiBH₄ + 2AlH₃→ | 12.4 | 106 | 39.6 | 83 | −18.4 |
| | 2AlB₂ + 4LiH + 9H₂ | | | | | |
| 2 | 2LiBH₄ + Al→ | 8.6 | 80 | 57.9 | 277 | −26.9 |
| | AlB₂ + 2LiH + 3H₂ | | | | | |
| 3* | 4LiBH₄ + MgH₂→ | 12.4 | 95 | 51.8 | 206 | −23.3 |
| | MgB₄ + 4LiH + 7H₂ | | | | | |
| 4* | 2LiBH₄ + Mg→ | 8.9 | 76 | 46.4 | 170 | −29.4 |
| | MgB₂ + 2LiH + 3H₂ | | | | | |
| 5 | 2LiBH₄ + TiH₂→ | 8.6 | 103 | 4.5 | | −23.3 |
| | TiB₂ + 2LiH + 4H₂ | | | | | |
| 6 | 2LiBH₄ + VH₂→ | 8.4 | 105 | 7.2 | −238 | −21.7 |
| | VB₂ + 2LiH + 4H₂ | | | | | |
| 7 | 2LiBH₄ + ScH₂→ | 8.9 | 99 | 32.6 | 26 | −21.4 |
| | ScB₂ + 2LiH + 4H₂ | | | | | |
| 8* | 2LiBH₄ + CrH₂→ | 8.3 | 109 | 16.4 | −135 | −19.2 |
| | CrB₂ + 2LiH + 4H₂ | | | | | |
| 9* | 2LiBH₄ + 2Fe→ | 3.9 | 76 | 12.8 | −163 | −24.6 |
| | 2FeB + 2LiH + 3H₂ | | | | | |
| 10 | 2LiBH₄ + 4Fe→ | 2.3 | 65 | 1.2 | | −24.4 |
| | 2Fe₂B + 2LiH + 3H₂ | | | | | |
| 11 | 2LiBH₄→Cr→ | 6.3 | 84 | 31.7 | 25 | −23.8 |
| | CrB₂ + 2LiH + 3H₂ | | | | | |
| 12 | Ca(BH₄)₂→ | 9.6 | 107 | 41.4 | 88 | −16.0 |
| | ⅔CaH₂ + ⅓CaB₆ + 10/3H₂ | | | | | |
| 13* | Ca(BH₄)₂ + MgH₂→ | 8.4 | 99 | 47.0 | 135 | −16.2 |
| | CaH₂ + MgB₂ + 4H₂ | | | | | |
| 14* | 2Ca(BH₄)₂ + MgH₂→ | 8.5 | 98 | 47.9 | 147 | −17.0 |
| | 2CaH₂ + MgB₄ + 7H₂ | | | | | |
| 15* | CA(BH₄)₂ + Mg→ | 6.4 | 79 | 41.9 | 111 | −22.0 |
| | CaH₂ + MgB₂ + 3H₂ | | | | | |
| 16* | Ca(BH₄)₂ + Al→ | 6.3 | 83 | 53.4 | 200 | −19.5 |
| | CaH₂ + AlB₂ + 3H₂ | | | | | |
| 17* | Ca(BH₄)₂ + AlH₃→ | 9.1 | 109 | 36.6 | 39 | −13.5 |
| | CaH₂ + AlB₂ + 9/2H₂ | | | | | |
| 18 | CA(BH₄)₂→ScH₂→ | 6.9 | 102 | 29.2 | −20 | −15.9 |
| | CaH₂ + ScB₂ + 4H₂ | | | | | |
| 19 | Ca(BH₄)₂ + TiH₂→ | 6.7 | 106 | 1.1 | | −17.7 |
| | CaH₂ + TiB₂ + 4H₂ | | | | | |
| 20 | Ca(BH₄)₂ + VH₂→ | 6.6 | 108 | 3.8 | | −16.2 |
| | CaH₂ + VB₂ + 4H₂ | | | | | |
| 21* | Ca(BH₄)₂ + CrH₂→ | 6.5 | 113 | 13.1 | −180 | −13.6 |
| | CaH₂ + CrB₂ + 4H₂ | | | | | |
| 22 | Ca(BH₄)₂→Cr→ | 5.0 | 86 | 27.2 | −38 | −16.4 |
| | CaH₂ + CrB₂ + 3H₂ | | | | | |
| 23 | 6LiBH₄ + CaH₂→ | 11.7 | 93 | 45.4 | 146 | −22.7 |
| | CaB₆ + 6LiH + 10H₂ | | | | | |
| 24 | 2LiBH₄ + MgH₂→ | 11.6 | 96 | 50.4 | 186 | −21.7 |
| | MgB₂ + 2LiH + 4H₂ | | | (41)^{b} | | |
| 25 | 2LiBH₄→ | 13.9 | 93 | 62.8 | 322 | −27.1 |
| | 2LiH + 2B + 3H₂ | | | (67)^{b} | | |
| 26 | LiBH₄→Li + B + 2H₂ | 18.5 | 124 | 89.7 | 485 | −15.3 |
| | | | | (96)^{c} | | |
| 27 | MgH₂→Mg + H₂ | 7.7 | 109 | 62.3 | 195 | 1.3 |
| | | | | (65.8-75.2)^{d} | | |

Turning first to the reactions from experiment (24-27), it is clear that the calculated enthalpies at temperature of T=300 K are generally in good agreement with the measured data. As to reaction 24, the calculated enthalpy of 50.4 kJ/mol H₂ overestimates the experimental value by about 10 kJ/mol. However, since the experimental measurements are made at temperatures (T=315-400° C.) above the LiBH₄ melting point (Tₘ=268° C.), and the calculated values are with respect to the ground state Pnma crystal structure, it is therefore expected that enthalpy at the crystal state is larger than the enthalpy at the liquid state.

### 2. Discussion

A key consideration in generating favorable hydrogen-storage reactions is to ensure that the thermodynamically preferred reaction pathway has been identified. This is a nontrivial task, and as detailed below, intuition alone is not sufficient to correctly identify realistic reactions involving multiple reactants. In this regard, several of the reactions in Table I (denoted by *) are noteworthy as they illustrate the difficulties that may arise by mere “guessing” at reactions. For example, all of the candidate reactions are represented in single-step reactions. However, some of these reactions should proceed via multiple-step pathways, with each step having thermodynamic properties that are distinct from the presumed single-step reactions.

The examples of how chemical intuition might fail are grouped into three categories:
(1) Reactant mixtures involving “weakly bound” compounds. Reactions falling under this category are characterized such that the enthalpy to decompose one (or more) of the reactants is less than the enthalpy of each proposed hydrogen desorption reaction presented in Table 1; thus, the weakly bound phase(s) will decompose before (i.e., at a temperature below that which) the destabilized reaction may proceed. Two examples are illustrated in Table I. The first example pertains to reactions 13-16, which, based on their larger enthalpies relative to reaction 12, would appear to “stabilize” Ca(BH₄)₂. In reality, Ca(BH₄)₂ will decompose before (with P_{H}_{₂}=1 bar at T=88° C.) any of the higher temperature reactions 13-16 will occur (T>110° C.), indicating that it is impossible to release hydrogen through a desorption reaction in this manner. The other example pertains to reactions 1, 8, 17, and 21, which involve the metastable AlH₃ and CrH₂ reactants. In the case of reaction 1, AlH₃ will decompose first (yielding Al and 3/2H₂), followed by reaction of Al with LiBH₄ (reaction 2). The consequences of this behavior are significant, since although the intended reaction 1 has an enthalpy (˜40 kJ/mol H₂) in the targeted range, in reality, the reaction will consist of two steps, the first of which has an enthalpy below the targeted range (AlH₃ decomposition), while the second (reaction 2) has an enthalpy above this range. Thermodynamic hydrogen desorption reaction screening criteria number 1: The enthalpy of each proposed hydrogen desorption reaction must be less than the decomposition enthalpy of each individual reactant involved in the reaction.
(2) Unstable combinations of product or reactant phases. Reaction 4 illustrates how the seemingly straightforward process of identifying stable reactant and product phases may become unexpectedly complex. Here, the starting mixture of LiBH₄ and Mg is unstable and undergoes the exothermic transformation,

2LiBH₄+Mg→ 3/2LiBH₄+¾MgH₂+¼MgB₂+½LiH, (3)

wherein the Mg is consumed to form MgH₂. MgH₂ then reacts endothermically with any remaining LiBH₄ according to the pathway shown in reaction 24 of Table I. It is noted that the enthalpy of reaction 4 (46.4 kJ/mol H₂) of Table I is lower than the decomposition enthalpy of MgH₂, illustrated in reaction 27 (62.3 kJ/mol H₂) of Table 1. As such, a mixture of LiBH₄ and Mg does not proceed reactively according to the reaction 4 listed in Table I but rather react to each other in a stepwise fashion according to the equation (3) shown above and the reaction 24 listed in Table I, wherein the total energy may be lowered since hydrogen is more strongly bound to magnesium. Thermodynamic hydrogen desorption reaction screening criteria number 2: If the proposed reaction involves a reactant that may absorb hydrogen (such as the elemental metal Mg of the reaction 4), the formation enthalpy of the corresponding hydride (such as MgH₂) should not be greater in magnitude than the enthalpy of the proposed hydrogen desorption reaction.
(3) Lower-energy reaction pathways. Reaction 3, involving a 4:1 mixture of LiBH₄:MgH₂, as well as the related reaction involving a 7:1 mixture of LiBH₄:MgH₂ according to 7LiBH₄+MgH₂→MgB₇+7LiH+11.5H₂ (not shown in the Table 1), both represent a single-step reactive mechanism resulting in the formation of MgB₄ and MgB₇, respectively. Based on further analysis as detailed below, it is noted that these seemingly intuitive reactive pathways may not proceed as suggested due to the presence of intermediate stages having lower energies. In fact, both hypothetical reactions have enthalpies of approximately 52 KJ/mol H₂ and are therefore larger than the enthalpy 50 KJ/mol H₂ of a counterpart 2:1 mixture according to the reaction 24 of Table I. These findings indicate that, upon heating, the 4:1 and 7:1 mixtures will proceed more favorably according to the reaction 24 of Table I, which will consume all available MgH₂. Subsequent reactions between unreacted LiBH₄ and newly formed MgB₂ will become thermodynamically feasible at temperatures above that of reaction 24 since their enthalpies exceed 50 kJ/mol H₂. Likewise, similar behavior is expected for reactions 9 and 10, as the 1:1 mixture of LiBH₄:Fe of reaction 9 will initially react in a 1:2 ratio according to reaction 10 of Table I, which presents a lower enthalpy. Thermodynamic hydrogen desorption reaction screening criteria number 3: For a single-step reaction, there generally exist only one stoichiometry among the thermodynamically stable reactants. Merely modifying the molar ratio of the reactants does not necessarily create new reactive pathways. In fact, and as shown above, a modified stoichiometry may necessatize hydrogen release in multiple steps with an initial step of the stoichiometry providing the lowest reaction enthalpy.

Moreover, mere substitution of an element in reactants may result in drastically different thermodynamic behaviors. For example, Ca(BH₄)₂ decomposes, according to reaction 12 of Table I, to release hydrogen requiring a reaction enthalpy of 41.4 KJ/mol H₂ and hydrogen releasing temperature of 88 degrees Celsius. LiBH₄, a compound with a simple substitution of Ca to Li in relation to Ca(BH₄)₂, decomposes to release hydrogen in a reaction (reaction 25 of Table 1) requiring a reaction enthalpy of 62.8 KJ/mol H₂ that is more than 20 KJ/mol H2 larger than the enthalpy in relation to reaction 12 and a hydrogen desorption temperature of 300 degrees Celsius, a prohibitively high temperature requiring excess energy to achieve. This example furthers the notion that merely guessing or simple modification based on intuition is not sufficient to generating hydrogen release reactions that are thermodynamically favorable.

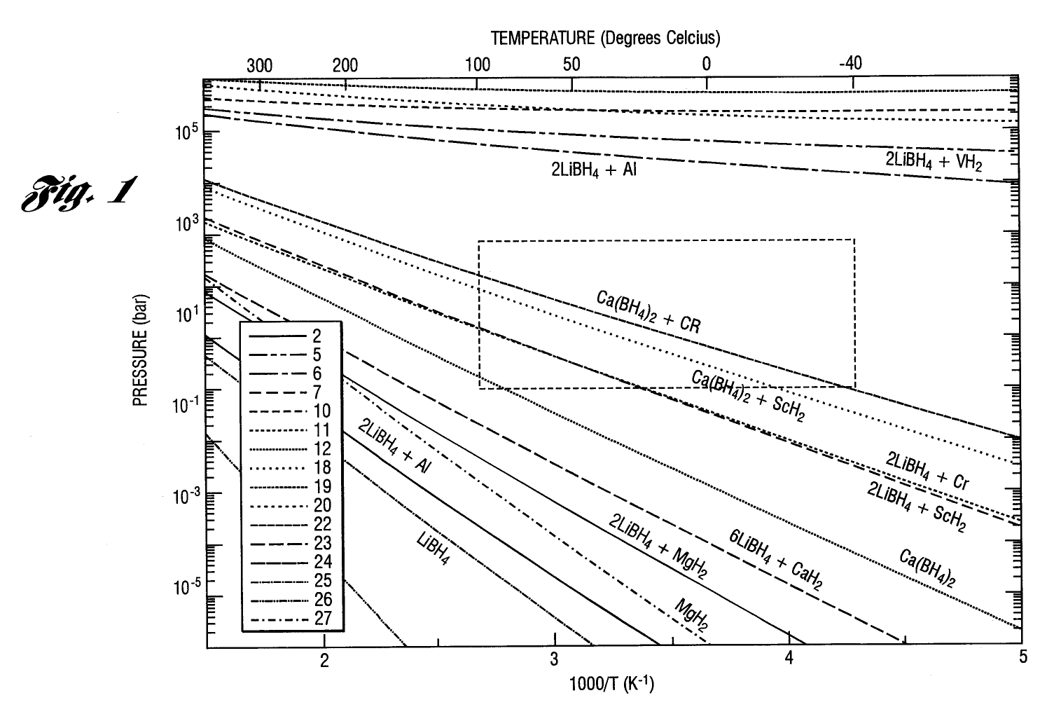

Preceding discussions in relation to various design criteria reveal that great care must be taken in predicting hydrogen-storage reactions. Having screened off reactions denoted “*” that have failed to satisfy the criterial limitations set forth above, the calculated thermodynamic date of the rest of the reactions in Table I, namely reactions 2, 5-7, 10-12, 18-20, and 22-27, are incorporated into FIG. 1 according to the van't Hoff equation,

$${P}_{{H}_{2}} = {P}_{0} exp ( - \frac{Δ G}{RT} ) ,$$

where P₀=1 bar. FIG. 1 plots equilibrium hydrogen desorption pressure as a function of temperature. Depicted also in the plot is a rectangle-shaped area delineating desirable temperature and pressure ranges for hydrogen storage: a temperature in the range of minus 40 to 100 degrees Celsius and a pressure in the range of 1-700 bar.

The van't Hoff plot as illustrated in FIG. 1 confirms that reactions having large dehydrogenation enthalpies, such as reactions 24-27, yield pressure P<<1 bar even at elevated temperatures. On the other hand, some other reactions having lower enthalpies, such as reactions 5 and 19, readily evolve hydrogen at very low temperatures; therefore hydrogen is bound too weakly within the reactant materials for practical, reversible on-board storage. For such a weakly-bound system impractically high pressures will be required to recharge the system with hydrogen. Quite contrarily, reactions involving mixtures identified in reactions 11, 18, and 22 desorb hydrogen presenting temperature and pressure regimes that strongly intersect the window of desirable operating conditions. Interestingly, reaction 7 is also shown to have temperature and pressure profile fitting nicely within the operating window of FIG. 1. These reactions have room-temperature enthalpies in the range of 27-33 kJ/mol H₂, reasonably acceptable hydrogen densities in the range of 5-8.9 weight percent and/or 85-100 grams hydrogen per liter, and achieve P_{H}_{₂}=1 bar at moderate temperatures ranging from −38 to 26 degrees Celsius. Thus, via a first-principles approach of rapid screening through a large number of candidate reactions, and the careful use of thermodynamic considerations to eliminate unstable or multistep reactions, we predict here several reactions with attributes that surpass the state-of-the-art for reversible, low-temperature storage materials.

### CONCLUSION

In conclusion, through the use of first-principles free energy calculations, discovered herein according to certain embodiments, are additional hydrogen releasing reactions from borohydride compounds of LiBH₄ and Ca(BH₄)₂ that have thermodynamics compatible with the operating conditions of mobile H₂-storage applications. Unlike other recent predictions, the proposed reactions utilize only known compounds with established synthesis routes and can therefore be subjected to immediate experimental testing. In addition, we provide guidance to subsequent efforts aimed at predicting H₂-storage materials by illustrating common pitfalls that arise when attempting to guess at reaction mechanisms, and by suggesting a set of thermodynamic guidelines to facilitate more robust predictions.

While the best mode for carrying out the invention has been described in detail, those familiar with the art to which this invention relates will recognize various alternative designs and embodiments for practicing the invention as defined by the following claims.

What is claimed:

1. A hydrogen storage material comprising:
a borohydride compound of the formula (1)
M(BH₄)ₙ (1)
wherein M includes Ca and n is an integer of 2 to 6; and
a destabilizing agent selected from the group consisting of Cr, ScH₂, and combinations thereof.

2. The hydrogen storage material of claim 1, wherein the borohydride compound is Ca(BH₄)₂ and the destabilizing agent is ScH₂.

3. The hydrogen storage material of claim 2, wherein Ca(BH₄)₂ and ScH₂ are present in a molar ratio of from 0.8:1.0 to 1.2:1.0.

4. The hydrogen storage material of claim 1, wherein the borohydride compound is Ca(BH₄)₂ and the destabilizing agent is Cr.

5. The hydrogen storage material of claim 4, wherein Ca(BH₄)₂ and Cr are present in a molar ratio of from 0.8:1.0 to 1.2:1.0.

6. The hydrogen storage material of claim 1, wherein M further includes a secondary element selected from the group consisting of Na, K, Mg, Sr, Mn, Ti, Al, Zr, Zn, and combinations thereof.

7. The hydrogen storage material of claim 1 further comprising at least one dopant selected from the group consisting of the transition metals, the rare earth metals, and combinations thereof.

8. The hydrogen storage material of claim 1, wherein the borohydride compound and the destabilizing agent collectively release hydrogen with a reactive enthalpy in the range of 20 to 50 kJ/mol hydrogen.

9. The hydrogen storage material of claim 1, wherein the borohydride and the destabilizing agent collectively release hydrogen at a temperature between −40 to 80 degrees Celsius.

10. The hydrogen storage material of claim 1, wherein the borohydride compound has a single-crystal volumetric hydrogen density about 50 percent higher than liquid hydrogen.

11. A hydrogen storage material comprising:
a borohydride compound of the formula (1)
M(BH₄)ₙ (1)
wherein M includes Li and n is an integer of 1 to 5; and
a destabilizing agent of Cr.

12. The hydrogen storage material of claim 11, wherein the borohydride compound is LiBH₄.

13. The hydrogen storage material of claim 11, wherein LiBH₄ and Cr are present in a molar ratio of from 1.8:1.0 to 2.2:1.0.

14. The hydrogen storage material of claim 11, wherein M further comprises a secondary element selected from the group consisting of Na, K, Mg, Sr, Mn, Ti, Al, Zr, Zn, and combinations thereof.

15. The hydrogen storage material of claim 11, wherein the borohydride compound and the destabilizing agent collectively release hydrogen with a reactive enthalpy in the range of 20 to 50 kJ/mol hydrogen.

16. The hydrogen storage material of claim 11, wherein the borohydride and the destabilizing agent collectively release hydrogen at a temperature between −40 to 80 degrees Celsius.

17. A method for storing and releasing hydrogen, the method comprising:
providing a hydrogen storage material comprising:
a borohydride compound of formula (I)
M(BH₄)ₙ (1)
wherein M includes Ca and n is an integer of 2 to 6; and a destabilizing agent selected from the group consisting of Cr, ScH₂, and combination thereof; and
inducing the hydrogen storage material to release hydrogen stored within the metal borohydride compound.

18. The method of claim 17, wherein the step of inducing is conducted at a temperature of between −40 and 80 degrees Celsius.

19. The method of claim 17, wherein the step of inducing is conducted at a pressure of between 1 to 700 bar.

20. The method of claim 17, wherein the step of inducing is conducted with a reactive enthalpy of between 20 to 50 kJ/mol hydrogen.
